(19) United States
(12) Patent Application Publication
(10) Pub. No.: US 2024/0121103 A1
(43) Pub. Date: Apr. 11, 2024

(54) ELECTRONIC DEVICE FOR PERFORMING SECURE COMMUNICATION BASED ON ASYMMETRIC KEY USING POLYNOMIAL RING AND THE OPERATING METHOD THEREOF

(71) Applicant: Industry-Academic Cooperation Foundation, Chosun University, Gwangju (KR)

(72) Inventors: Chanki KIM, Gwangju (KR); Young Sik KIM, Gwangju (KR)

(73) Assignee: Industry-Academic Cooperation Foundation, Chosun University, Gwangju (KR)

(21) Appl. No.: 18/103,415

(22) Filed: Jan. 30, 2023

(30) Foreign Application Priority Data
Sep. 26, 2022 (KR) 10-2022-0121755

(51) Int. Cl. H04L 9/32; H04L 9/40

(52) U.S. Cl. CPC H04L 9/3242; H04L 63/0442

(57) ABSTRACT

Disclosed are an electronic device for performing secure communication based on an asymmetric key using a polynomial ring and the operating method thereof to support secure communication having quantum resistance to be enabled.

### CROSS-REFERENCE TO RELATED APPLICATIONS

This application claims priority to and the benefit of Korean Patent Application No. 10-2022-0121755 filed in the Korean Intellectual Property Office on Sep. 26, 2022, the entire contents of which are incorporated herein by reference.

### TECHNICAL FIELD

The present invention relates to an electronic device for performing secure communication based on an asymmetric key using a polynomial ring and the operating method thereof.

### BACKGROUND ART

Recently, as the performance of a computer system is high, it is necessary to introduce a more enhanced encryption system.

In particular, due to the introduction of quantum computers, interest in bilateral resistance encryption technology for defending attacks through quantum computers is increasing.

The introduction of code-based encryption technology is being discussed among these quantum resistance encryption technologies, and the code-based encryption technology as a technology that performs encryption using a block code used for error correction may be regarded as a technology that encrypts data by randomly inserting a predetermined error vector into data and performs decoding by a scheme of detecting an error vector through decoding for the error correction.

In the code-based encryption technology, in order to be resistant to pattern attacks through the quantum computers, an important for the decoding technology that detects an error from predetermined encoded data may be regarded to be large in that random error information on the data is inserted as encryption information.

In this regard, as a recent decoding technology for detecting the error from the encoded code, rank support recovery (RSR) has been proposed. The RSR is an algorithm that can rebuild a vector space E of error vectors having a rank weight r from a syndrome for a low-rank parity-check (LRPC) code. Since the code-based encryption technology using the LRPC code is a rank metric based encryption system, the code-based encryption technology has a feature of keeping a high security with a small key size.

### SUMMARY OF THE INVENTION

The present invention has been made in an effort to provide an electronic device for performing secure communication based on an asymmetric key using a polynomial ring and the operating method thereof to support secure communication having quantum resistance to be enabled.

An exemplary embodiment of the present invention provides an electronic device for performing secure communication based on asymmetric key using polynomial ring, which includes: a storing unit storing Hash(⋅) which is a predetermined hash function, and P which is an n/b (n and b are integers)-degree predetermined primitive polynomial, in which Hash(⋅) and P are also stored in a counterpart electronic terminal specified to perform the secure communication; a vector selection unit randomly selecting random vectors x and y are randomly selected from F which is a set of n/b-tuple vectors having a rank weight d (d is the integer); a polynomial selection unit randomly selecting P_{I} which is a (b−1)-degree primitive polynomial in a polynomial ring constituted by a set of primitive polynomials having a maximum degree of n/b, and randomly selecting P_{O} and P_{N} which are n-degree primitive polynomials in a polynomial ring constituted by a set of primitive polynomials having a maximum degree of n; a first computing unit computing n/b-tuple vector z=(z=P_{I}x⁻¹y mod P) based on x, y, and P_{I}; a second computing unit computing a public key polynomial P_{P} (P_{P}=P_{O}P_{I} mod P^{b}) based on P_{I} and P_{O} and a public key vector h (h=P_{O}z+P_{N}P mod P^{b}) based on P_{O}, z, and P_{N}; and a key distribution unit designating P_{P} and h as the public key, designating x, y, P_{I}, and P_{O} designated as a private key corresponding to the public key, and then transmitting P_{P} and h designated as the public key to the counterpart electronic device which is to perform secure communication.

Another exemplary embodiment of the present invention provides an operating method of an electronic device for performing secure communication based on asymmetric key using polynomial ring, which includes: maintaining a storing unit storing Hash(⋅) which is a predetermined hash function, and P which is an n/b (n and b are integers)-degree predetermined primitive polynomial, in which Hash(⋅) and P are also stored in a counterpart electronic terminal specified to perform the secure communication; randomly selecting random vectors x and y are randomly selected from F which is a set of n/b-tuple vectors having a rank weight d (d is the integer); randomly selecting P_{I} which is a (b−1)-degree primitive polynomial in a polynomial ring constituted by a set of primitive polynomials having a maximum degree of n/b, and randomly selecting P_{O} and P_{N} which are n-degree primitive polynomials in a polynomial ring constituted by a set of primitive polynomials having a maximum degree of n; computing n/b-tuple vector z (=P_{I}x⁻¹y mod P) based on x, y, and P_{I}; computing a public key polynomial P_{P} (P_{P}=P_{O}P_{I} mod P^{b}) based on P_{I} and P_{O} and a public key vector h (h=P_{O}z+P_{N}P mod P^{b}) based on P_{O}, z, and P_{N}; and designating P_{P} and h as the public key, designating x, y, P_{I}, and P_{O} designated as a private key corresponding to the public key, and then transmitting P_{P} and h designated as the public key to the counterpart electronic device which is to perform secure communication.

According to an exemplary embodiment of the present invention, an electronic device for performing secure communication based on an asymmetric key using a polynomial ring and the operating method thereof are provided to support secure communication having quantum resistance to be enabled.

### BRIEF DESCRIPTION OF THE DRAWINGS

FIG. 1 is a diagram illustrating a structure of an electronic device for performing secure communication based on an asymmetric key using a polynomial ring according to an exemplary embodiment of the present invention.

FIG. 2 is a flowchart illustrating an operating method of an electronic device for performing secure communication based on an asymmetric key using a polynomial ring according to an exemplary embodiment of the present invention.

### DETAILED DESCRIPTION

Hereinafter, exemplary embodiments of the present invention will be described in detail with reference to the accompanying drawings. The description does not limit the present invention to specific exemplary embodiments, and it should be understood that the present invention covers all the modifications, equivalents and replacements included within the idea and technical scope of the present invention. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present invention, each of components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning computer program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

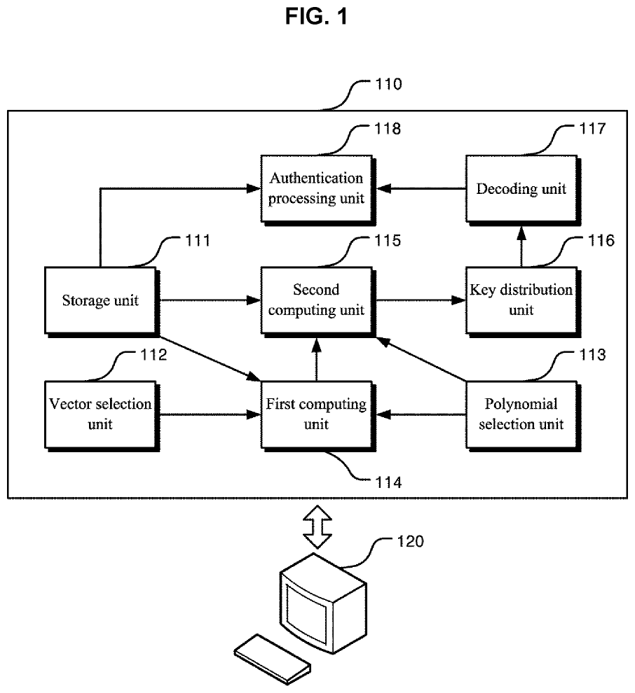

FIG. 1 is a diagram illustrating a structure of an electronic device for performing secure communication based on an asymmetric key using a polynomial ring according to an exemplary embodiment of the present invention.

Referring to FIG. 1, an electronic device 110 according to the present invention includes a storage unit 111, a vector selection unit 112, a polynomial selection unit 113, a first computing unit 114, a second computing unit 115, and a key distribution unit 116.

The storage unit 111 stores Hash(⋅) which is a predetermined hash function, and P which is an n/b (n and b are integers)-degree predetermined primitive polynomial.

Here, Hash(⋅) and P are also stored in a counterpart electronic terminal 120 specified to perform the secure communication.

The vector selection unit 112 randomly selects random vectors x and y from F which is a set of n/b-tuple vectors having a rank weight d (d is the integer).

The polynomial selection unit 113 randomly selects P_{I} which is a (b−1)-degree primitive polynomial in a polynomial ring constituted by a set of primitive polynomials having a maximum degree of n/b, and randomly selects P_{O} and P_{N} which are n-degree primitive polynomials in a polynomial ring constituted by a set of primitive polynomials having a maximum degree of n.

In this case, P_{I}, and P_{O} and P_{N} are primitive polynomials satisfying Equations 1 and 2 below.

P_{I}∈ [symbol] _{q}_{^{m}}[X]/<P> [Equation 1]

P_{O},P_{N}∈ [symbol] _{q}_{^{m}}[X]/<P^{b}> [Equation 2]

Here, [symbol] _{q}_{^{m}} represents a finite field by extension of a field [symbol] _{q}.

The first computing unit 114 computes n/b-tuple vector z according to Equation 3 below based on x, y, and P_{I}.

z=P_{I}x⁻¹y mod P [Equation 3]

The second computing unit 115 computes a public key polynomial P_{P} according to Equation 4 below based on P_{I} and P_{O} and, and computes a public key vector h according to Equation 5 below based on P_{O}, z, and P_{N}.

P_{P}=P_{O}P_{I} mod P^{b} [Equation 4]

h=P_{O}z+P_{N}P mod P^{b} [Equation 5]

The key distribution unit 116 designates P_{P} and h as the public key, designates x, y, P_{I}, and P_{O} as a private key corresponding to the public key, and then transmits P_{P} and h designated as the public key to the counterpart electronic device 120 which is to perform secure communication.

In this case, according to an exemplary embodiment of the present invention, the counterpart electronic device 120 may previously store Hash(⋅) and P on a memory, and when P_{P} and h designated as the public key are received from the electronic device 110, P_{P} and h may stored on the memory.

Thereafter, when a situation in which mutual authentication with the electronic device 110 should be performed occurs, the counterpart electronic device 120 may generate a ciphertext based on the P_{P} and h designated as the public key, and transmit the ciphertext to the electronic device 110.

Specifically, the counterpart electronic device 120 may randomly select random vectors e₁ and e₂ from E which is the set of the n/b-tuple vectors having a maximum degree of

$$\frac{n}{b} - b$$

and having the rank weight r (r is the integer).

Then, the counterpart electronic device 120 may generate e′₁=[0, e₁], e′₂=[0, e₂], and h′=[0, h] which are vectors having a length of n based on e₁, e₂, and h.

Thereafter, the counterpart electronic device 120 may generate the ciphertext c according to a computing of Equation 6 below based on e′₁, e′₂, h′, and P_{P}.

c=P_{P}e′₁+h′e′₂ mod P^{b} [Equation 6]

As such, when c is generated, the counterpart electronic device 120 applies E to Hash(⋅) as an input to compute a hash value K(K=Hash(E)), and then transmit c and K to the electronic device 110.

In this case, according to an exemplary embodiment of the present invention, the electronic device 110 may further include a decoding unit 117 and an authentication processing unit 118.

When the decoding unit 117 receives c and K from the counterpart electronic device 120, the decoding unit 117 generates a syndrome vector xc″ᵢ by performing the computing of Equation 7 below based on x, P_{I}, and P_{O} designed as the private key, and then performs rank support recovery (RSR) decoding for xc″ᵢ to rebuild E.

c′ᵢ=P_{O}⁻¹c mod P^{b},

c″ᵢ=P_{I}⁻¹{c′ᵢ mod P} mod P,

xc″ᵢ=xe₁+ye₂ mod P [Equation 7]

In this regard, a process of generating xc″ᵢ from the computing of Equation 7 above will be described below in detail.

First, referring to a first line of Equation 7 above, {c′ᵢ mod P}={P_{O}⁻¹c mod P^{b}} mod P may be expressed.

In this case, {P_{O}⁻¹c mod P^{b}} mod P is c=P_{P}e′₁+h′e′₂ mod P^{b} and P_{P}=P_{O}P_{I} mod P_{b}, {P_{I}e′₁ mod P^{b}}+{P_{O}⁻¹h′e′₂ mod P^{b}} mod P may be expressed.

In this case, {P_{I}e′₁ mod P^{b}} mod P may be represented as in Equation 8 below.

{({P_{I} mod P}[0,e₁])mod P^{b}} mod P={(P_{I}e₁)mod P} mod P [Equation 8]

In addition, {P_{O}⁻¹h′e′₂ mod P^{b}} mod P may be represented as in Equation 9 below.

$$\begin{matrix}\{ {P}_{O}^{- 1} {h}^{′} {e}_{2}^{′} mod {P}^{b} \} mod P = \{ ( {P}_{N} P + [ 0 , \{ {P}_{I} {x}^{- 1} y mod P \} ] ) \\ [ 0 , {e}_{2} ] mod {P}^{b} \} mod P \\ = \{ {P}_{I} {x}^{- 1} y mod P \} \{ {e}_{2} mod P \} \\ = \{ {P}_{I} {x}^{- 1} {ye}_{2} mod P \}\end{matrix} \qquad [ Equation 9 ]$$

Consequently, {c′ᵢ mod P} mod P is acquired by combining {P_{I}e′₁ mod P^{b}} mod P and {P_{O}⁻¹h′e′₂ mod P^{b}} mod P, and may be organized as in Equation 10 below.

$$\begin{matrix}\{ {c}_{i}^{′} mod P \} mod P = \{ ( {P}_{I} {e}_{1} ) mod P \} + \{ {P}_{I} {x}^{- 1} {ye}_{2} mod P \} \\ = {P}_{I} {e}_{1} + {P}_{I} {x}^{- 1} {ye}_{2} mod P\end{matrix} \qquad [ Equation 10 ]$$

As shown in Equation 10 above, since {c′ᵢ mod P} mod P may be organized into P_{I}e₁+P_{I}x⁻¹ye₂ mod P, when computing for a second line is performed in Equation 7 above, c″ᵢ may be computed by e₁+x⁻¹ye₂ mod P, and as a result, xc″ᵢ according to a third line in Equation 8 above may be computed.

When rebuilding E is completed through the decoding unit 117, the authentication processing unit 118 applies the rebuilt E to the Hash(⋅) as the input to generate a hash value K′(K′=Hash (E)), and then compares whether K′ and K coincide with each other, and processes that authentication for the counterpart electronic device 120 is completed when it is identified that K′ and K coincide with each other.

That is, the authentication processing unit 118 compares both hash values to identify whether E rebuilt by performing the RSR decoding for the syndrome vector xc″ᵢ by the decoding unit 117 and E used for selecting the random vectors by the counterpart electronic device 120 coincide with each other, and when it is identified that both Es coincide with each other, authenticate whether the counterpart electronic device 120 matches an electronic device which normally possesses the public key distributed through the key distribution unit 116.

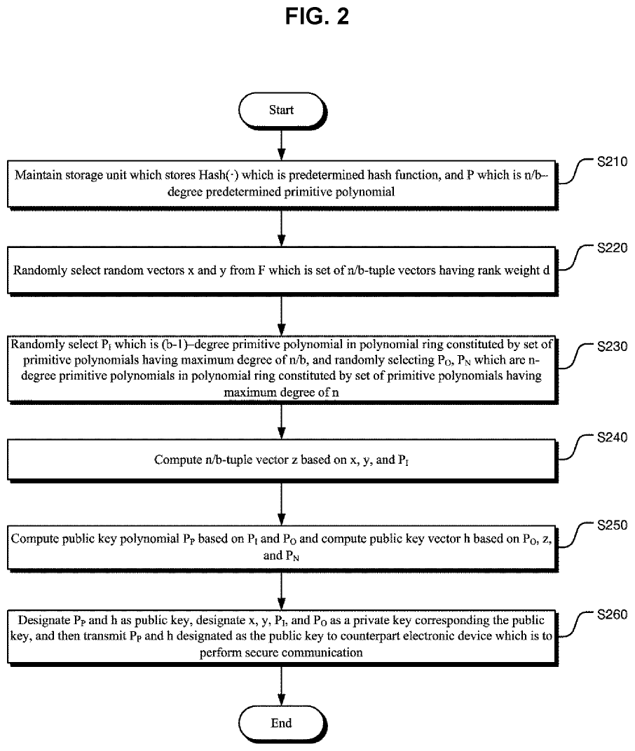

FIG. 2 is a flowchart illustrating an operating method of an electronic device for performing secure communication based on an asymmetric key using a polynomial ring according to an exemplary embodiment of the present invention.

In step S210, a storage unit is maintained, which stores Hash(⋅) which is a predetermined hash function, and P which is an n/b (n and b are integers)-degree predetermined primitive polynomial.

Here, Hash(⋅) and P are also stored in a counterpart electronic terminal specified to perform the secure communication.

In step S220, random vectors x and y are randomly selected from F which is a set of n/b-tuple vectors having a rank weight d (d is the integer).

In step S230, P_{I} which is a (b−1)-degree primitive polynomial is randomly selected in a polynomial ring constituted by a set of primitive polynomials having a maximum degree of n/b, and P_{O} and P_{N} which are n-degree primitive polynomials are randomly selected in a polynomial ring constituted by a set of primitive polynomials having a maximum degree of n.

In step S240, n/b-tuple vector z (z=P_{I}x⁻¹y mod P) is computed based on x, y, and P_{I}.

In step S250, a public key polynomial P_{P} (P_{P}=P_{O}P_{I} mod P^{b}) is computed based on P_{I} and P_{O} and a public key vector h (h=P_{O}z+P_{N}P mod P^{b}) is computed based on P_{O}, z, and P_{N}.

In step S260, P_{P} and h are designated as the public key, x, y, P_{I}, and P_{O} are designated as a private key corresponding to the public key, and then P_{P} and h designated as the public key are transmitted to the counterpart electronic device which is to perform secure communication.

In this case, according to an exemplary embodiment of the present invention, the counterpart electronic device may previously store Hash(⋅) and P on a memory, and when P_{P} and h designated as the public key are received from the electronic device, store P_{P} and h on the memory, and then when a situation in which mutual authentication with the electronic device should be performed occurs, the counterpart electronic device may randomly select random vectors e₁ and e₂ from E which is the set of the n/b-tuple vectors having a maximum degree of

$$\frac{n}{b} - b$$

and having the rank weight r (r is the integer), generate e′₁=[0, e₁], e′₂=[0, e₂], and h′=[0, h] which are vectors having a length of n based on e₁, e₂, and h, and then generate the ciphertext c (c=P_{P}e′₁+h′e′₂ mod P^{b}) based on e′₁, e′₂, h′, and P_{P} and apply E to Hash(⋅) as an input to compute a hash value K(K=Hash(E)), and then transmit c and K to the electronic device.

In this case, according to an exemplary embodiment of the present invention, the operating method of the electronic device may further include a step of when c and K are received from the counterpart electronic device, generating a syndrome vector xc″ᵢ by performing the computing of Equation 7 above based on x, P_{I}, and P_{O} designed as the private key, and then performing RSR decoding for xc″ᵢ to rebuild E, and a step of applying the rebuilt E to the Hash(⋅) as the input to generate a hash value K′(K′=Hash(E)), and then comparing whether K′ and K coincide with each other, and processing that authentication for the counterpart electronic device is completed when it is identified that K′ and K coincide with each other.

Hereinabove, the operating method of the electronic device according to an exemplary embodiment of the present invention is described with reference to FIG. 2. Here, since the operating method of the electronic device according to an exemplary embodiment of the present invention may correspond to the configuration of the operation of the electronic device 110 described by using FIG. 1, a more detailed description thereof will be omitted.

The operating method of the electronic device according to an exemplary embodiment of the present invention may be implemented by a computer program stored in a storage medium for executing the computer program through coupling with a computer.

The operating method of the electronic device according to an exemplary embodiment of the present invention are implemented in a form of a program command which may be performed through various computer means and may be recorded in the computer readable medium. The computer readable medium may include a program command, a data file, a data structure, etc., singly or combinationally. The program command recorded in the medium may be specially designed and configured for the present invention, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present invention has been described by specified matters such as detailed components, and the like and limited exemplary embodiments and drawings, but the description is just provided to assist more overall understanding of the present invention and the present invention is not limited to the exemplary embodiment and various modifications and changes can be made by those skilled in the art from such a disclosure.

Accordingly, the spirit of the present invention should not be defined only by the described exemplary embodiments, and it should be appreciated that claims to be described below and all things which are equivalent to the claims or equivalently modified to the claims are included in the scope of the spirit of the present invention.

What is claimed is:

1. An electronic device for performing secure communication based on asymmetric key using polynomial ring, comprising:
a storage unit storing Hash(⋅) which is a predetermined hash function, and P which is an n/b (n and b are integers)-degree predetermined primitive polynomial, in which Hash(⋅) and P are also stored in a counterpart electronic terminal specified to perform the secure communication;
a vector selection unit randomly selecting random vectors x and y from F which is a set of n/b-tuple vectors having a rank weight d (d is the integer);
a polynomial selection unit randomly selecting P_{I} which is a (b−1)-degree primitive polynomial in a polynomial ring constituted by a set of primitive polynomials having a maximum degree of n/b, and randomly selecting P_{O} and P_{N} which are n-degree primitive polynomials in a polynomial ring constituted by a set of primitive polynomials having a maximum degree of n;
a first computing unit computing n/b-tuple vector z (z=P_{I}x⁻¹y mod P) based on x, y, and P_{I};
a second computing unit computing a public key polynomial P_{P} (P_{P}=P_{O}P_{I} mod P^{b}) based on P_{I} and P_{O} and a public key vector h (h=P_{O}z+P_{N}P mod P^{b}) based on P_{O}, z, and P_{N}; and
a key distribution unit designating P_{P} and h as the public key, designating x, y, P_{I}, and P_{O} designated as a private key corresponding to the public key, and then transmitting P_{P} and h designated as the public key to the counterpart electronic device which is to perform secure communication.

2. The electronic device of claim 1, wherein the counterpart electronic device previously stores Hash(⋅) and P on a memory, and when P_{P} and h designated as the public key are received from the electronic device, stores P_{P} and h on the memory, and then when a situation in which mutual authentication with the electronic device should be performed occurs, randomly selects random vectors e₁ and e₂ from E which is the set of the n/b-tuple vectors having a maximum degree of
$$\frac{n}{b} - b$$
and having the rank weight r (r is the integer), generates e′₁=[0, e₁], e′₂=[0, e₂] and h′=[0, h] which are vectors having a length of n based on e₁, e₂, and h, and then generates the ciphertext c (c=P_{P}e′₁+h′e′₂ mod P^{b}) based on e′₁, e′₂, h′, and P_{P} and applies E to Hash(⋅) as an input to compute a hash value K(K=Hash(E)) and then transmits c and K to the electronic device.

3. The electronic device of claim 2, further comprising:
a decoding unit generating a syndrome vector xc″ᵢ by performing the computing of Equation 1 below based on x, P_{I}, and P_{O} designed as the private key when receiving c and K from the counterpart electronic device, and then performing rank support recovery (RSR) decoding for xc″ᵢ to rebuild E; and
an authentication processing unit applying the rebuilt E to the Hash(⋅) as the input to generate a hash value K′(K′=Hash(E)), and then comparing whether K′ and K coincide with each other, and processing that authentication for the counterpart electronic device is completed when it is identified that K′ and K coincide with each other.
c′ᵢ=P_{O}⁻¹c mod P^{b},
c″ᵢ=P_{I}⁻¹{c′ᵢ mod P} mod P,
xc″ᵢ=xe₁+ye₂ mod P [Equation 1]

4. An operating method of an electronic device for performing secure communication based on asymmetric key using polynomial ring, comprising:
maintaining a storing unit storing Hash(⋅) which is a predetermined hash function, and P which is an n/b (n and b are integers)-degree predetermined primitive polynomial, in which Hash(⋅) and P are also stored in a counterpart electronic terminal specified to perform the secure communication;
randomly selecting random vectors x and y from F which is a set of n/b-tuple vectors having a rank weight d (d is the integer);
randomly selecting P_{I} which is a (b−1)-degree primitive polynomial in a polynomial ring constituted by a set of primitive polynomials having a maximum degree of n/b, and randomly selecting P_{O} and P_{N} which are n-degree primitive polynomials in a polynomial ring constituted by a set of primitive polynomials having a maximum degree of n;
computing n/b-tuple vector z (z=P_{I}x⁻¹y mod P) based on x, y, and P_{I};
computing a public key polynomial P_{P} (P_{P}=P_{O}P_{I} mod P^{b}) based on P_{I} and P_{O} and a public key vector h (h=P_{O}z+P_{N}P mod P^{b}) based on P_{O}, z, and P_{N}; and
designating P_{P} and h as the public key, designating x, y, P_{I}, and P_{O} designated as a private key corresponding to the public key, and then transmitting P_{P} and h designated as the public key to the counterpart electronic device which is to perform secure communication.

5. The operating method of claim 4, wherein the counterpart electronic device previously stores Hash(⋅) and P on a memory, and when P_{P} and h designated as the public key are received from the electronic device, stores P_{P} and h on the memory, and then when a situation in which mutual authentication with the electronic device should be performed occurs, randomly selects random vectors e₁ and e₂ from E which is the set of the n/b-tuple vectors having a maximum degree of
$$\frac{n}{b} - b$$
and having the rank weight r (r is the integer), generates e′₁=[0, e₁], e′₂=[0, e₂] and h′=[0, h] which are vectors having a length of n based on e₁, e₂, and h, and then generates the ciphertext c ( ) c=P_{P}e′₁+h′e′₂ mod P^{b} based on e′₁, e′₂, h′, and P_{P} and applies E to Hash(⋅) as an input to compute a hash value K(K=Hash(E)), and then transmits c and K to the electronic device.

6. The operating method of claim 5, further comprising:
when receiving c and K from the counterpart electronic device, generating a syndrome vector xc″ᵢ by performing the computing of Equation 1 below based on x, P_{I}, and P_{O} designed as the private key, and then performing rank support recovery (RSR) decoding for xc″ᵢ to rebuild E; and
applying the rebuilt E to the Hash(⋅) as the input to generate a hash value K′(K″=Hash(E)), and then comparing whether K′ and K coincide with each other, and processing that authentication for the counterpart electronic device is completed when it is identified that K′ and K coincide with each other.
c′ᵢ=P_{O}⁻¹c mod P^{b},
c″ᵢ=P_{I}⁻¹{c′ᵢ mod P} mod P,
xc″ᵢ=xe₁+ye₂ mod P [Equation 1]

7. A non-transitory computer readable recording medium having a program recorded therein for allowing a computer to execute an operating method of an electronic device for performing secure communication based on asymmetric key using polynomial ring, comprising:
maintaining a storing unit storing Hash(⋅) which is a predetermined hash function, and P which is an n/b (n and b are integers)-degree predetermined primitive polynomial, in which Hash(⋅) and P are also stored in a counterpart electronic terminal specified to perform the secure communication;
randomly selecting random vectors x and y from F which is a set of n/b-tuple vectors having a rank weight d (d is the integer);
randomly selecting P_{I} which is a (b−1)-degree primitive polynomial in a polynomial ring constituted by a set of primitive polynomials having a maximum degree of n/b, and randomly selecting P_{O} and P_{N} which are n-degree primitive polynomials in a polynomial ring constituted by a set of primitive polynomials having a maximum degree of n;
computing n/b-tuple vector z (z=P_{I}x⁻¹y mod P) based on x, y, and P_{I};
computing a public key polynomial P_{P} (P_{P}=P_{O}P_{I} mod P^{b}) based on P_{I} and P_{O} and a public key vector h (h=P_{O}z+P_{N}P mod P^{b}) based on P_{O}, z, and P_{N}; and
designating P_{P} and h as the public key, designating x, y, P_{I}, and P_{O} designated as a private key corresponding to the public key, and then transmitting P_{P} and h designated as the public key to the counterpart electronic device which is to perform secure communication.
